(19) United States
(12) Patent Application Publication
(10) Pub. No.: US 2005/0007712 A1
(43) Pub. Date: Jan. 13, 2005

(54) Apparatus for controlling multi-outlet power strip

(76) Inventor: Sang-Keun Shim, Seoul (KR)

Correspondence Address: Jonathan P. Osha;OSHA & MAY L.L.P., Suite 2800, 1221 McKinney Street, Houston, TX, 77010, US

(21) Appl. No.: 10/875,786

(22) Filed: Jun. 22, 2004

(30) Foreign Application Priority Data
Jun. 24, 2003 (KR) 10-2003-40908

(51) Int. Cl. H02H 3/20

(52) U.S. Cl. 361/91.5

(57) ABSTRACT

An apparatus for controlling a multi-outlet power strip, in which the above-described switch vibration can be avoided, and which can be easily fabricated along with reduction in the manufacturing cost is provided. Detector detects electric current flowing through the main plug connector. Amplifier amplifies the electric current detected by the current detector to produce an amplified signal. Schmitt trigger circuit compares the amplified signal from the amplifier with a reference value, and outputs a control signal for a vibration prevention having a predetermined threshold voltage according to the compared result. Switch operator switches an electric power to the plurality of auxiliary connectors. Driver drives the detector, the amplifier, the Schmitt trigger circuit, and the switch operator.

### BACKGROUND OF THE INVENTION

1. Field of the Invention

The present invention relates to an apparatus for controlling a multi-outlet power strip, particularly to such an apparatus which can be applied to an electrical wiring system having a multiple outlets to which plural electric devices are electrically connected. More particularly, in the present invention, by sensing the electric current flowing to a main device, the electric power supplied to other sub-devices can be automatically cut-off, depending on whether or not the main device is turned on.

2. Description of the Related Art

FIG. 1 schematically shows the general concept of the multi-outlet control circuit, in which reference numeral 20 denotes a multi-outlet control circuit. As shown in FIG. 1, the multi-outlet power strip 10 is provided with a main outlet 11 to which the main computer is electrically connected, and plural sub-outlet 12 to 14 where various peripheral devices are electrically connected. An alternating current (for example, 220V) is applied directly to the main outlet 11. On the contrary, the sub-outlets 12 to 14 are connected to an alternating power source via a switch 26, which will be hereinafter explained in detail.

The multi-outlet control circuit 20 comprises a current detector 21 for detecting current variation, depending on whether or not the main computer 50 is operated or turned on. The current detector 21 is connected to an alternating power line leading to the main outlet 11. In addition, the multi-outlet control circuit 20 includes a signal amplifier 22 for amplifying to a certain level an output current from the current detector 21, a controller 23 for identifying the on/off-state of the main computer 51 and outputting a control signal proportional to the identified state, a switch operator 24 for turning off or on a switch 26 to cut off the electric power (for example 220V) to the sub-outlets 12 to 14 responding to the control signal from the controller 23, and a power supply 25 for supplying an electric power to the signal amplifier 22, the controller 23, and the switch operator 24.

In the conventional multi-outlet control circuit having the construction described above, the main computer 51 is electrically connected to the main outlet 11 and the peripheral devices such as the monitor 52, the printer 53, the scanner 54 or the like are connected to the sub-outlets 12 to 14.

In operation, when the main computer 51 is operated or turned on, due to the electric consumption the current detector 21 detects a current. Otherwise, any current will not be detected in the current detector 21.

Therefore, only in the case where the current detector 21 detects a current flowing through the main outlet 11, it outputs a signal. This signal is amplified to a certain level via the signal amplifier 22 and applied to the signal comparator 23.

In subsequence, when the amplified signal from the signal amplifier 22 is applied to the controller 23, the controller 23 recognizes the main computer 51 being turned-on and operates the switch operator 24 to maintain the on-state of the on/off switch 26. Therefore, the alternating current can be supplied continuously to the sub-outlets 12 to 14 and consequently to the peripheral devices.

On the other hand, when any signal is not applied to the controller 23, the controller 23 recognizes the main computer being turned-off and operates the switch operator 24 such that the on/off switch 26 is switched to the off-state, thereby cutting off the electric power being supplied to the sub-outlets 12 to 14, to which the peripherals are plugged.

As described above, where the main computer 51 and the peripheral devices are used while being connected respectively to the main outlet 11 and the sub-outlets 12 to 14 of the multi-outlet power strip 10, all the power supply to the computer system can be cut-off when the main computer 51 is turned off. As the result, possible damages due to a surge by a thunderbolt or the like can be avoided, along with prevention of unnecessary power consumption.

FIG. 2 illustrates an example of the multi-outlet control circuit, which is disclosed in Korean Patent Publication No. 2003-31554. As shown in FIG. 2, the current detector 21 comprises a current transformer (CT) connected to the output terminal of the power supply 25 for changing the current value, and a stabilizing circuit 34 composed of diodes D3 and D4 for rectifying the output current from the current transformer and a condenser C3 for leveling the rectified current. The current detected by the current transformer and the stabilizing circuit 34 is applied to the controller 23 via the signal amplifier 22.

The above-described conventional multi-outlet control circuit, however, necessitates an expensive and large-sized current transformer for the current detector 21 to detect electric current flowing to the main outlet 11.

Furthermore, a problem occurs in that, when a certain critical value is input to the switch operator 24, the output value of the switch operator may be fluctuated.

### SUMMARY OF THE INVENTION

Accordingly, the present invention has been made in view of the above problems in the prior art, and it is an object of the present invention to provide to an apparatus for controlling a multi-outlet power strip, in which the above-described switch vibration can be avoided, and which can be easily fabricated along with reduction in the manufacturing cost.

According to an aspect of the invention, there is provided an apparatus for controlling a multi-outlet power strip having a main plug connector and a plurality of auxiliary plug connectors electrically connected to a main electric device and a plurality of peripheral devices, respectively, the apparatus comprising:

a detector for detecting electric current flowing through the main plug connector;

an amplifier for amplifying the electric current detected by the current detector to produce an amplified signal;

a Schmitt trigger circuit for comparing the amplified signal from the amplifier with a reference value, and outputting a control signal for a vibration prevention having a predetermined threshold voltage according to the compared result; and

a switch operator operated by the control signal from the Schmitt trigger circuit for switching an electric power to the plurality of auxiliary connectors; and

a driver for driving the detector, the amplifier, the Schmitt trigger circuit, and the switch operator.

Preferably, wherein the detector includes a shunt resistor. More preferably, the Schmitt trigger circuit includes a first diode for receiving the amplified signal from the amplifier, a first capacitor having one terminal connected to a cathode of a first diode and another terminal connected to a ground, a first resistor having one terminal connected to the cathode of the first diode and the one terminal of the first capacitor, a second resistor having one terminal connected to a power supply, a second diode and a second capacitor connected in parallel with each other between the ground and another terminal of the second resistor, and a comparator having an inverting input connected to the another terminal of the second resistor and a non-inverting input connected to another terminal of the first resistor.

Most preferably, the switch operator includes a first resistor having one terminal connected to an output terminal of the Schmitt trigger circuit, a second resistor having one terminal connected to another terminal of the first resistor, a transistor having a base connected to a junction between the another terminal of the first resistor and the one terminal of the second resistor, and a switch element connected to a collector of the transistor. Further, the switching element includes at least one of a relay, a solid state relay, a triac, and a thyristor. The apparatus further comprises a noise filter for preventing an externally unnecessary electric wave from being introduced into the multi-outlet power strip and preventing an unnecessary electric wave generated in the multi-outlet power strip from being exposed to an outside.

A further understanding of other features, aspects and advantages of the invention will be realized by reference to the following description, the accompanying drawings and the appended claims.

### BRIEF DESCRIPTION OF THE DRAWINGS

Preferred embodiment(s) of the present invention will be described with reference to the accompanying drawings, in which:

FIG. 1 schematically shows the general concept of the multi-outlet control circuit;

FIG. 2 illustrates an example of the conventional multi-outlet control circuit;

FIG. 3 illustrates a general computer system, in which a main computer and peripheral devices are electrically connected to a multi-outlet power strip;

FIG. 4 illustrates an apparatus for controlling a multi-outlet power strip according to one embodiment of the invention; and

FIG. 5 shows an enlarged view of the multi-outlet power strip and the shunt resistor in FIG. 4.

### DETAILED DESCRIPTION

Referring to the accompanying drawings, the preferred embodiments according to the present invention are described in detail hereafter. The same reference numerals used in different figures denote similar or identical components.

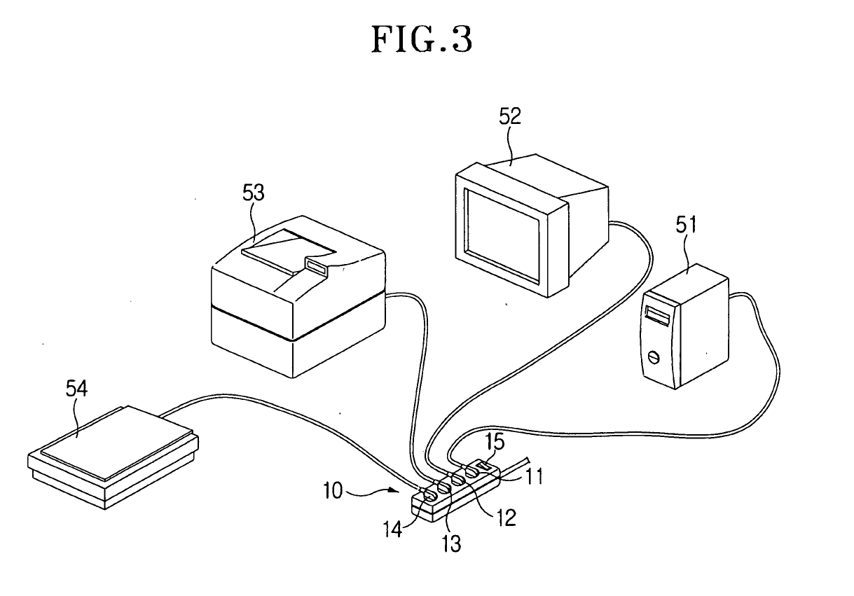

FIG. 3 illustrates a general computer system, in which peripheral devices are plugged to a multi-outlet power strip, along with a main computer. As shown in FIG. 3, the main computer 51 is used, generally together with a plurality of peripheral devices, for example, a monitor 52, a printer 53, a scanner 54, a speaker (not shown) and the like. An alternating current is supplied to the main computer 51 and the peripheral devices via a multi-outlet power strip 10, in which a plurality of outlets 11 to 14 are provided for the devices to be connected.

Therefore, users must use a switch 15 provided in the multi-outlet power strip 10 in order to cut off the electric power supplied to the peripheral devices, after finishing the use of the main computer 51.

In general, the multi-outlet power strip 10 is placed under the desk where the computer system is installed, or other places not seen by users, so as not to spoil the view surrounding the computer system. Accordingly, it is cumbersome for the users to cut-off the whole power using the switch 15 of the multi-outlet power strip 10. In addition, the users are apt to forget to turn off the peripheral devices after turning off the main computer 51. Thus, occasionally the peripheral devices may be damaged by a surge resulted from a thunderbolt and the like, together with unnecessary energy consumption.

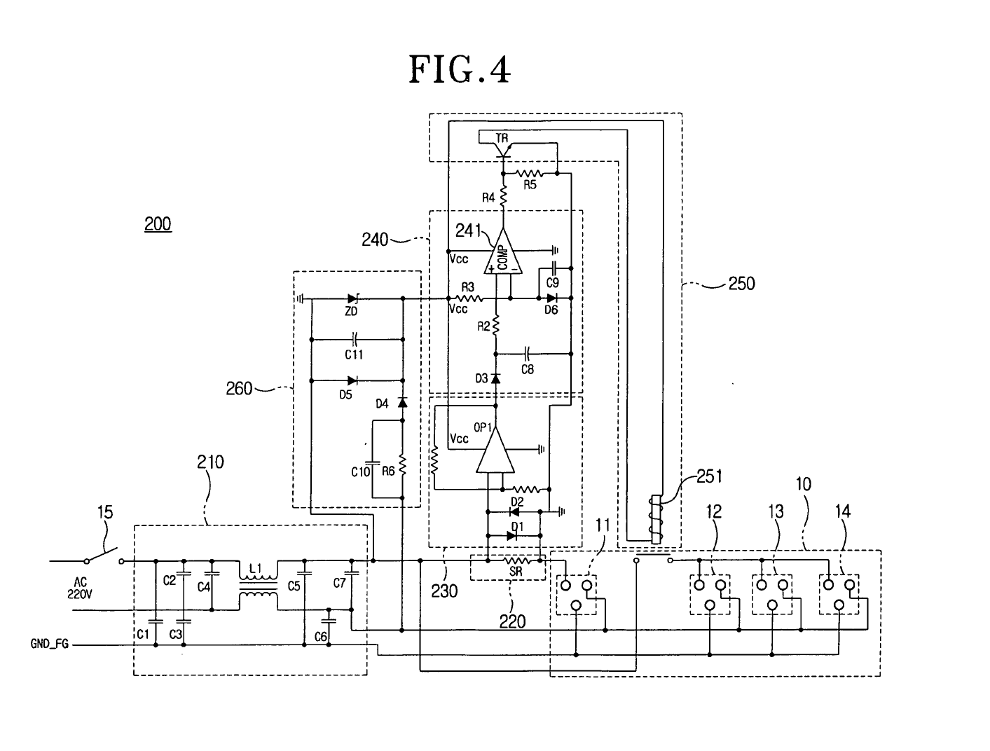

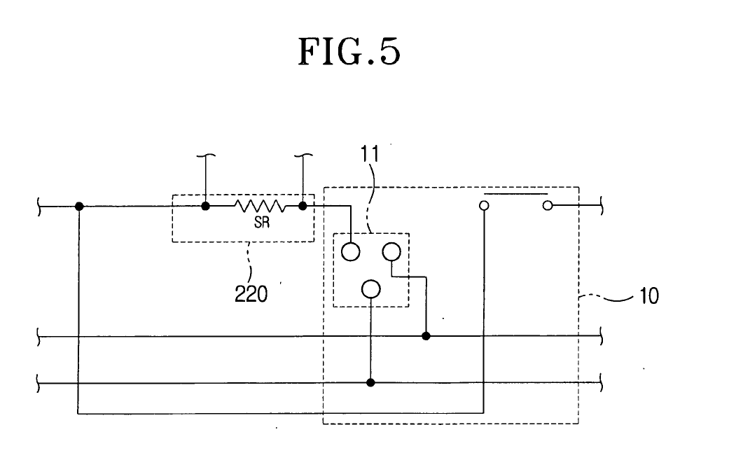

FIG. 4 illustrates an apparatus for controlling a multi-outlet power strip according to one embodiment of the invention, in which the apparatus is generally denoted by a reference numeral 200. FIG. 5 shows an enlarged view of the multi-outlet power strip and the shunt resistor in FIG. 4.

Referring to FIGS. 4 and 5, the apparatus 200 of the invention comprises a current detector 220, an amplifier 230, a Schmitt trigger circuit 240, a switch operator 250, a noise filter 210, and a driver 260. Each component of the apparatus of the invention will be explained below in greater detail.

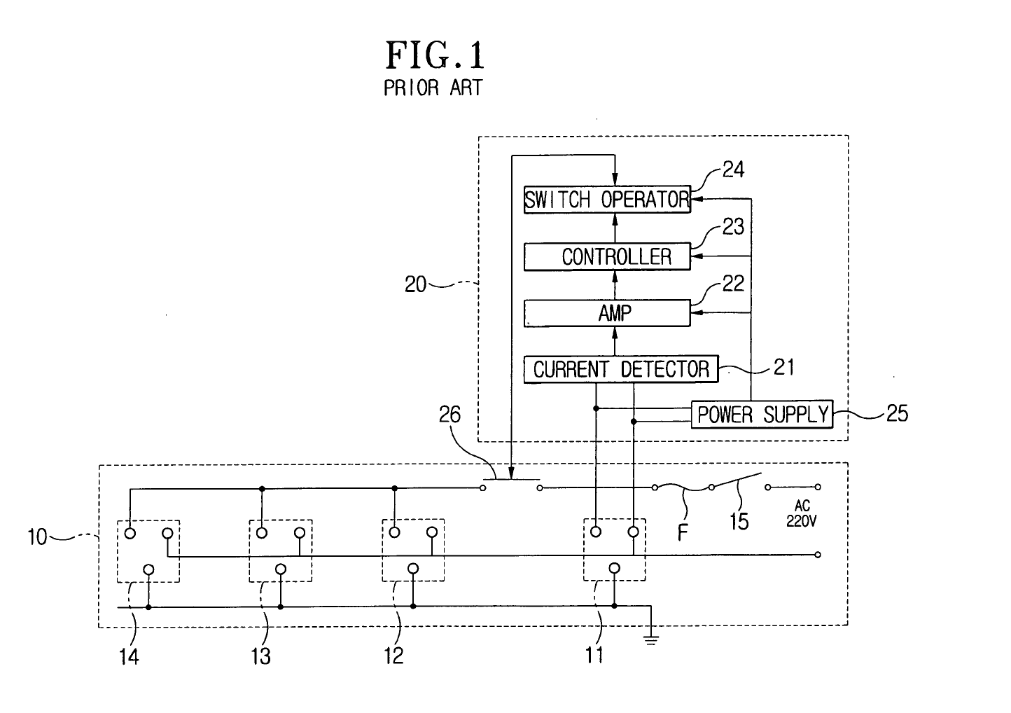

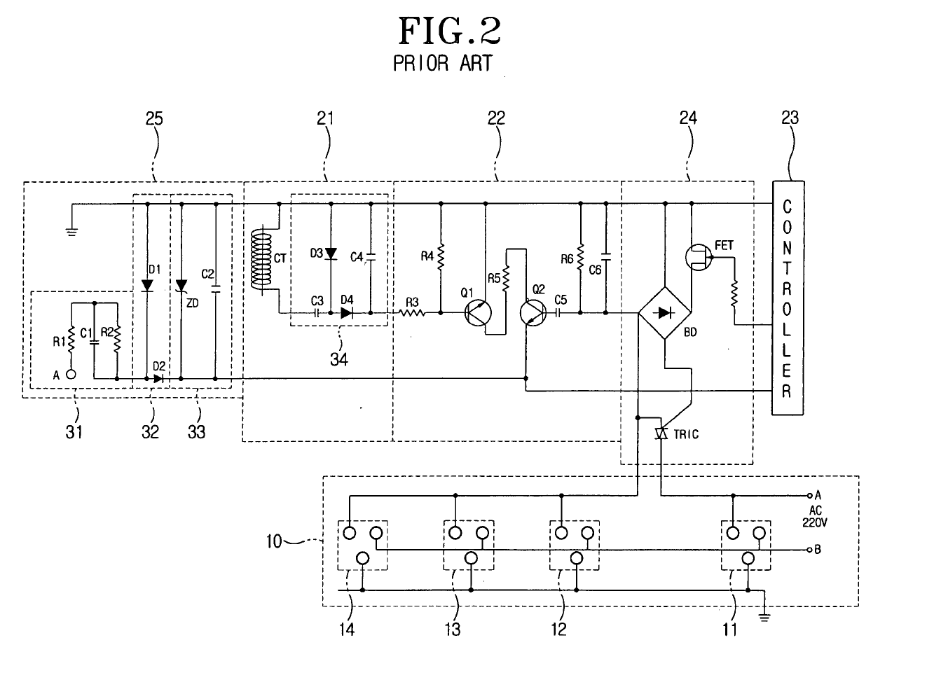

The current detector 220 detects electric current flowing through a main plug connector 11 of a multi-outlet power strip 10 (shown in FIGS. 1 to 3). In this embodiment, a shunt resistance capable of detecting micro-current is employed as the current detector 220. In addition, the current detector 220 is connected in series with the main plug connector 11.

The signal amplifier 230 serves to amplify a micro-signal output from the current detector 220 and produces an amplified signal.

In the signal comparator 240, the amplified signal in the signal amplifier 230 is compared with a certain reference value, so as to recognize whether a main device, i.e., a main computer 51 (not shown in FIG. 4) is turned on or off and output a control signal.

The noise filter 210 prevents unnecessary electric wave from entering a multi-outlet power strip 10. For example, a surge caused by a thunderbolt or the like is shut off, and the unnecessary electric wave is prevented from leaking to the outside of the apparatus 200.

The Schmitt trigger circuit 240 compares the amplified signal from the amplifier 230 with a reference value, and outputs a control signal for a vibration prevention having a predetermined threshold voltage according to the compared result.

The Schmitt trigger circuit 240 includes a first diode D3 for receiving the amplified signal from the amplifier 230, a first capacitor C8 having one terminal connected to a cathode of a first diode D3 and another terminal connected to a ground, a first resistor R2 having one terminal connected to the cathode of the first diode D3 and the one terminal of the first capacitor C8, a second resistor R3 having one terminal connected to a power supply Vcc, a second diode D3 and a second capacitor C9 connected in parallel with each other between the ground and another terminal of the second resistor R3. The Schmitt trigger circuit 240 includes a comparator 241 having an inverting input connected to the another terminal of the second resistor and a non-inverting input connected to another terminal of the first resistor. The comparator 241 compares the amplified signal with the reference value and outputting a control signal according to the compared result.

As described above, the Schmitt trigger circuit functions to apply a voltage less than a certain critical value to the switch operator 250, thereby preventing vibration of a switching element 251.

Where a switching element, which is operated to be “on” at 3V, is employed, it can be switched to an “off” state at a little lower voltage. For example, in the range of 2.8-2.9V, the switching element is apt to vibrate between on and off positions. According to the invention, the signal comparator 240 uses the Schmitt trigger circuit in order to operate the switching element 251 to switch to the “off” state at a certain voltage lower than, for example, 2.5V in the case of the above 3V switch, thereby preventing the on/off vibration of the switching element.

The switch operator 250 includes a transistor, which operates the switching element 251 to cut off the power being supplied to the sub-outlets 12 to 14, depending on the presence of the control signal output from the signal comparator 240. The switching element 251 is connected to the output end of the transistor.

The switch operator 250 includes a first resistor R4 having one terminal connected to an output terminal of the Schmitt trigger circuit 240, and a second resistor R5 having one terminal connected to another terminal of the first resistor R4, a transistor TR having a base connected to a junction between the another terminal of the first resistor R4 and the one terminal of the second resistor R5, and a switch element 251 connected to a collector of the transistor TR.

Preferred switching element 251 is a relay, a solid state relay (SSR), a triac, a thyristor or the like.

The driver 260 drives the shunt resistor 220, the amplifier 230, the Schmitt trigger circuit 240, and the switch operator 250, respectively.

The noise filter 210 prevents an externally unnecessary electric wave from being introduced into the multi-outlet power strip 10 and prevents an unnecessary electric wave generated in the multi-outlet power strip 10 from being exposed to an outside.

Furthermore, as depicted in FIGS. 4 and 5, the current detector 220 and the main plug connector 11 is connected with each other in series, and also the wiring of the apparatus of the invention is designed to supply an electric power separately to the main outlet 11 and the sub-outlets 12 to 14. Therefore, the current detector 220 detects only the electric current flowing through the main plug connector 11, to which the main device (i.e., the main computer 51 in FIG. 3) is electrically connected.

In operation, where the output of the current detector 220 is higher than a predetermined reference value, the Schmitt trigger circuit 240 recognizes the main device, for example, the main computer 51 connected to the main outlet 11, as being turned-on. Then, it outputs a signal, for example a ‘high’ signal, to the transistor, which, in turn, becomes a turn-on state according to the ‘high’ signal. Therefore, an electric power from the driver 260 is rendered to pass the transistor of the switch operator 250 and actuate the switching element 251 to be switched to the on-state. Therefore, the electric power from the multi-outlet power strip can be supplied to the sub-outlets 12 to 14 of the multi-outlet power strip and consequently to the peripheral devices connected thereto, such as a monitor, printer and the like.

On the contrary, when the output of the current detector 220 is lower than a predetermined reference value, the signal comparator 240 recognizes the main computer 51 as being turned-off. Then, it outputs a signal, for example a ‘low’ signal, to the transistor, which, in turn, becomes a turn-off state according to the ‘low’ signal. Therefore, an electric power from the power supply 260 does not pass the transistor of the switch operator 250, so that electric power is cut off from the sub-plug connectors 12 to 14 of the multi-outlet power strip and consequently from the peripheral devices connected thereto, such as a monitor, printer and the like.

In this description, a multi-outlet power strip is illustrated as one preferred embodiment of the present invention, but not limited thereto. The invention may be applied to various other electrical wiring systems, in which some of equipment connected thereto is desired to be automatically turned on or turned off, depending on the turned-on or turn-off state of other equipment.

According to the present invention, in a wiring system having a plurality of electric equipment connected thereto, a shunt resistance is used in order to recognize whether or not main equipment is operated or turned-on. As the result, a reliable circuit can be easily fabricated, along with reduction in the manufacturing cost. Furthermore, a Schmitt trigger circuit is employed to output a control signal, according to the result of comparison of the signal from the current detector with a predetermined reference value. Therefore, the switching operator is operated at less than a certain critical value, thereby preventing the vibration of the switching element.

While the present invention has been described with reference to preferred embodiments, the description is illustrative of the invention and is not to be construed as limiting the invention. Various modifications and variations may occur to those skilled in the art without departing from the scope and spirit of the present invention as defined by the appended claims.

1. An apparatus for controlling a multi-outlet power strip having a main plug connector and a plurality of auxiliary plug connectors electrically connected to a main electric device and a plurality of peripheral devices, respectively, the apparatus comprising:
a detector for detecting electric current flowing through the main plug connector;
an amplifier for amplifying the electric current detected by the current detector to produce an amplified signal;
a Schmitt trigger circuit for comparing the amplified signal from the amplifier with a reference value, and outputting a control signal for a vibration prevention having a predetermined threshold voltage according to the compared result; and
a switch operator operated by the control signal from the Schmitt trigger circuit for switching an electric power to the plurality of auxiliary connectors; and
a driver for driving the detector, the amplifier, the Schmitt trigger circuit, and the switch operator, respectively.

2. An apparatus according to claim 1, wherein the detector includes a shunt resistor.

3. An apparatus according to claim 1, wherein the Schmitt trigger circuit includes a first diode for receiving the amplified signal from the amplifier, a first capacitor having one terminal connected to a cathode of a first diode and another terminal connected to a ground, a first resistor having one terminal connected to the cathode of the first diode and the one terminal of the first capacitor, a second resistor having one terminal connected to a power supply, a second diode and a second capacitor connected in parallel with each other between the ground and another terminal of the second resistor, and a comparator having an inverting input connected to the another terminal of the second resistor and a non-inverting input connected to another terminal of the first resistor.

4. An apparatus according to claim 1, wherein the switch operator includes a first resistor having one terminal connected to an output terminal of the Schmitt trigger circuit, a second resistor having one terminal connected to another terminal of the first resistor, a transistor having a base connected to a junction between the another terminal of the first resistor and the one terminal of the second resistor, and a switch element connected to a collector of the transistor.

5. An apparatus according to claim 4, wherein the switching element includes at least one of a relay, a solid state relay, a triac, and a thyristor.

6. An apparatus according to claim 1, further comprising a noise filter for preventing an externally unnecessary electric wave from being introduced into the multi-outlet power strip and preventing an unnecessary electric wave generated in the multi-outlet power strip from being exposed to an outside.

7. An apparatus for controlling a multi-outlet power strip having a main plug connector and a plurality of auxiliary plug connectors electrically connected a main electric device and a plurality of peripheral devices, respectively, the apparatus comprising:
a detector for detecting electric current flowing through the main plug connector;
an amplifier for amplifying the electric current detected by the current detector to produce an amplified signal;
a Schmitt trigger circuit for comparing the amplified signal from the amplifier with a reference value, and outputting a control signal for a vibration prevention having a predetermined threshold voltage according to the compared result; and
a switch operator operated by the control signal from the Schmitt trigger circuit for switching an electric power to the plurality of auxiliary connectors;
a driver for driving the detector, the amplifier, the Schmitt trigger circuit, and the switch operator, respectively; and
a noise filter for preventing an externally unnecessary electric wave from being introduced into the multi-outlet power strip and preventing an unnecessary electric wave generated in the multi-outlet power strip from being exposed to an outside.

8. An apparatus according to claim 7, wherein the Schmitt trigger circuit includes a first diode for receiving the amplified signal from the amplifier, a first capacitor having one terminal connected to a cathode of the first diode and another terminal connected to a ground, a first resistor having one terminal connected to the cathode of the first diode and the one terminal of the first capacitor, a second resistor having one terminal connected to a power supply, a second diode and a second capacitor connected in parallel with each other between the ground and another terminal of the second resistor, and a comparator having an inverting input connected to the another terminal of the second resistor and a non-inverting input connected to another terminal of the first resistor.

9. An apparatus according to claim 7, wherein the switch operator includes a first resistor having one terminal connected to an output terminal of the Schmitt trigger circuit, a second resistor having one terminal connected to another terminal of the first resistor, a transistor having a base connected to a junction between the another terminal of the first resistor and the one terminal of the second resistor, and a switch element connected to a collector of the transistor.
